(19) United States
(12) Patent Application Publication
(10) Pub. No.: US 2007/0243905 A1
(43) Pub. Date: Oct. 18, 2007

(54) Method and Apparatus for Operating user Interface of Mobile Terminal Having Pointing Device

(75) Inventors: Sung Chul Juh, Seoul (KR); Yoon Soo Kim, Seoul (KR); Sun Jun, Gyeonggi-do (KR); Kyu Min Hwang, Seoul (KR); Jung Hun Choi, Seoul (KR)

Correspondence Address: VENABLE LLP, P.O. BOX 34385, WASHINGTON, DC, 20043-9998, US

(73) Assignee: Mobisol Inc., Seoul (KR)

(21) Appl. No.: 11/628,984

(22) PCT Filed: Jun. 13, 2005
(86) PCT No.: PCT/KR05/01780

§ 371 Date: Dec. 8, 2006

(30) Foreign Application Priority Data
Jun. 12, 2004 (KR) 10-2004-0043271

(51) Int. Cl. H04B 1/40

(52) U.S. Cl. 455/566

(57) ABSTRACT

The present invention relates to a method and an apparatus for operating user interface of a mobile terminal having a pointing device. A mobile terminal having a pointing device comprising: a pointing device generating and transmitting button and motion data by user's manipulation, a control section controlling at least a datum processed by a button data processing section processing button data or a motion data processing section processing motion data transmitted from the pointing device, and an application program interface managing user interface by receiving control data, wherein the user interface environment is reorganized by the control data generated by users' manipulation and an element forming the environment is downloadable.

### TECHNICAL FIELD

The present invention is related to a mobile terminal having pointing device; and, more particularly, method and apparatus for operating user interface of mobile terminal having pointing device.

### BACKGROUND ART

In prior arts, users have to use a key pad provided with a mobile terminal to select a specific function therein. A characteristic of the mobile terminal as a potable device subjects a size of the mobile terminal, and the key pad of the mobile terminal has a uniform structure due to the size restriction. In spite of the uniform structure of key pad, increasement of functions mounted in the mobile terminal is in trend with development of electronic, electric, and telecommunication technologies. This trend has resulted in increasement of functions assigned in each key of the key pad. For that reason, users have to inconveniently use multi-step key input to move to a desired function with referring to a manual displayed on a screen of the mobile terminal. A soft key has been introduced and used to overcome this inconvenience. The soft key is a key method using a software which selects a specific function by inputting plurality of special keys. However, this soft key method have not overcome the inconvenience in a point. Users have to get used to a plurality of key input steps.

FIG. 1 describes a schematic output screen and a key pad formation of a prior mobile terminal.

Referring to FIG. 1, users, for example, select message write item by inputting a specific key of a key pad referring to a menu screen displayed on a output section (101), after inputting a key corresponding to a outgoing message to send a message. In other word, users to select a desired item input a key by using direction keys (107) and select keys (105) referring to a function icon (103) in a menu screen displayed on the output section (101). For more detail, users move to a specific item (for example, ‘write’) by using the direction keys, and thereafter, select the specific item by using the select key (105). If users select the specific, the mobile terminal displays a screen corresponding to ‘write’ on the output section (101).

According to the prior mobile terminal from FIG. 1, users have to input plurality of keys to select a specific item, and therefore users not used to the prior mobile terminal cannot realistically use various mobile telecommunication services except a call service. Even for users used to the prior mobile terminal, a difficulty and an excessive time of manipulating the key pad are problems for using applications such as a navigation system, an MP3 player, and a game. In addition, a function and an environment of a user interface of the prior mobile terminal is priory set when it is manufactured from a manufacturer, and not configurable by users or service providers.

### DISCLOSURE OF INVENTION

### Technical Problem

An objective of the present invention is providing a method and apparatus for operating user interface of a mobile terminal having a pointing device, wherein users can configure a user interface screen.

Other objective of the present invention is providing a method and apparatus for operating user interface of a mobile terminal having a pointing device, wherein users can easily select a function by selecting a specific icon.

Other objective of the present invention is providing a method and apparatus for operating user interface of a mobile terminal having a pointing device, wherein users can configure various environment by downloading various factors forming the environment through wire/wireless connection.

Other objective of the present invention is providing a method and apparatus for operating user interface of a mobile terminal having a pointing device, wherein users can easily program a specific mountable function.

### TECHNICAL SOLUTION

To achieve these objectives, a mobile terminal having a pointing device comprising: a pointing device generating and transmitting button and motion data by user's manipulation, a control section controlling at least a datum processed by a button data processing section processing button data or a motion data processing section processing motion data transmitted from the pointing device, and an application program interface managing user interface by receiving control data, wherein the user interface environment is configured by the control data generated by users' manipulation, and an element forming the environment is downloadable.

To achieve other objects, a method of operating an user interface of a mobile terminal having a pointing device comprising: receiving at least a datum of button data or motion data with the pointing device, generating control data based on received button data or motion data, generating high level command in an application programming interface to manage the user interface based on the control data, and operating the user interface by the high level command compared with the control data, wherein an environment of the user interface is manipulated by the control data generated by the user, and an environmental element is downloadable.

For example, the high level command is generated in an application programming interface (CD-GUI Application programming interface: CD-GUI API). Also, the control data based on the button data is one of click data, double click data, drag start data, drag data, button press data, button release data, and drop data. Also, the control data based on the motion data is a coordinate data. Also, the motion data is an velocity data, and the coordinate data is generated from one of the velocity data, an accelerate data generated from the velocity data, and a pre-set coordinate data of the mouse pointer. Also the user interface (CD-GUI) is divided into configurable area which is configurable by user's manipulation and protected area which is not configurable by uses.

### BRIEF DESCRIPTION OF THE DRAWINGS

FIG. 1 illustrates a schematic drawing of a output form and key pad structure of a mobile terminal.

FIG. 2 explains a schematic drawing of a user interface of the mobile terminal having a pointing device.

FIG. 3 depicts a schematic drawing of a system structure of the mobile terminal having the pointing device.

FIG. 4 represents a schematic drawing of an apparatus for operating the user interface of the mobile terminal having the pointing device.

FIG. 5 presents a detailed drawing of CD-GUI API and CD-GUI.

FIG. 6 shows a schematic drawing of a system structure of a control section.

FIG. 7 demonstrates a flow chart about processing button data.

FIG. 8 illustrates a flow chart about processing motion data.

FIG. 9 explains a drawing of a method of user environment buffering.

FIG. 10 depicts a drawing of a screen using CD-GUI.

FIG. 11 through 16 show a drawing of a screen representing examples of each function mounted in the mobile terminal according to the present invention.

FIG. 17 represents a drawing of user screen structure.

FIG. 18 demonstrates a drawing of a start screen on a display section.

FIG. 19 presents a drawing of a operating status of a specific application program.

FIG. 20 illustrates a drawing of a service provider area and a configurable area in a user environment.

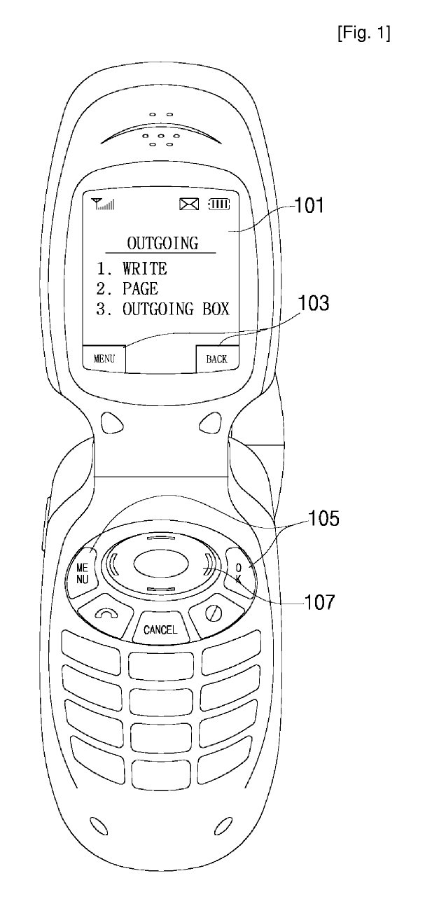

### BEST MODE FOR CARRYING OUT THE INVENTION

Reference will now be made in detail to the preferred embodiments of the present invention, examples of which are illustrated in the accompanying drawings.

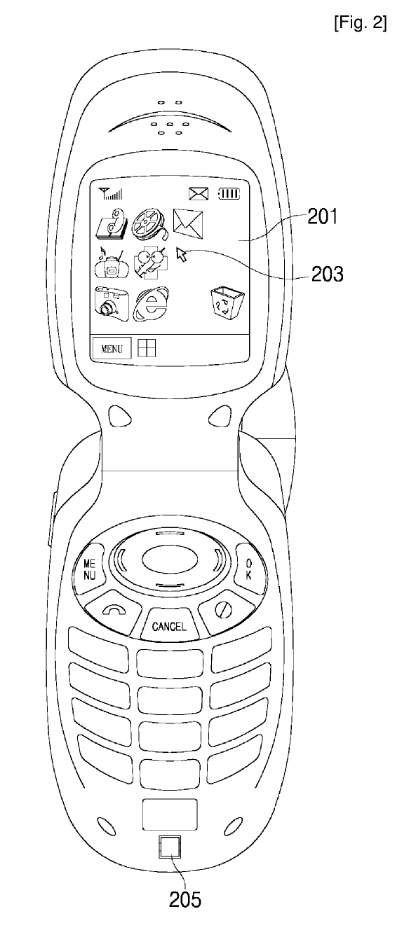

FIG. 2 explains a schematic drawing of a user interface of the mobile terminal having a pointing device. Referring to FIG. 2, a mobile terminal according to the present invention includes a key pad, a pointing device (205), and an output section (201). Explanation of the key pad is not described here because it is the same in the shape and function from a prior mobile terminal. The pointing device (205) generates button data and motion data by user's manipulation, and transmits them to a control section (not shown). The control section (not shown) generates coordinate data based on the button data and the motion data received from the pointing device (205), and thereafter moves a position of a mouse pointer (203) or runs an event about a specific icon by generating click data, double click data, drag start data, drag data, button press data, button release data, and drop data. The output section (201) generates a CD-UI (Configurable and Downloadable User Interface).

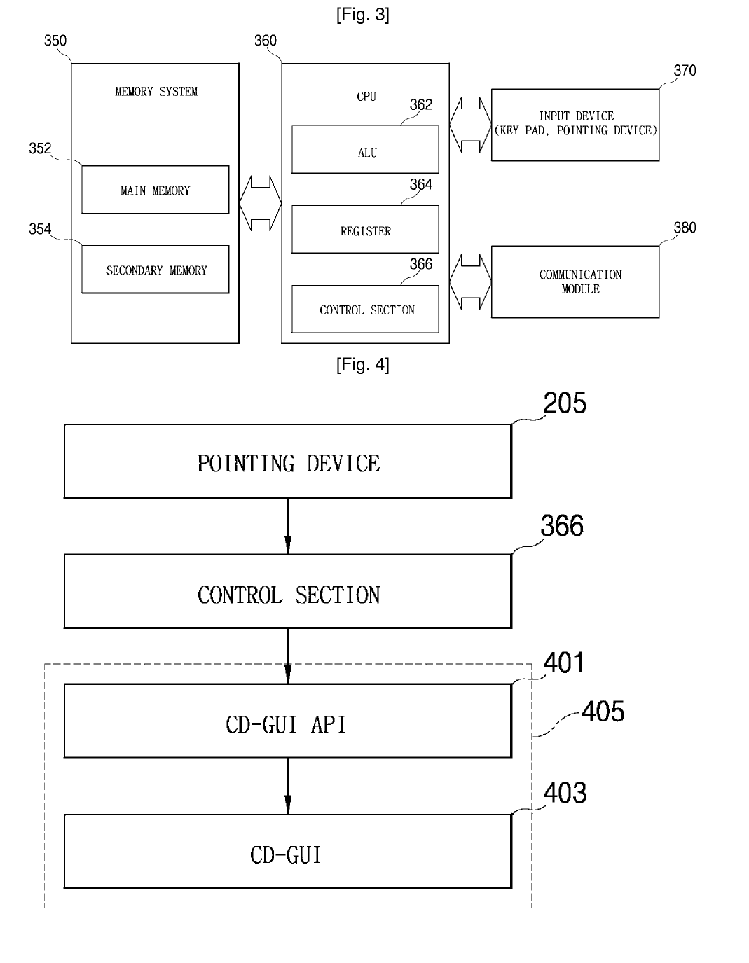

FIG. 3 depicts a schematic drawing of a system structure of the mobile terminal having the pointing device. Referring to FIG. 3, the mobile terminal includes a memory system (350), at least one of CPU (Central Processing Unit: 360) which accomplishes high speed operation with connecting to the memory system, an input devices (370), and a communication module (380).

The CPU (360) includes an ALU (Arithmetic Logic Unit: 362) to accomplish a calculation, a register (364) to temporarily store data and commands, and a control section (366) to control an operation of the mobile terminal. The memory system (350) includes a high speed main memory (352) such as RAM (Random Access Memory) and ROM (Read Only Memory), and a secondary memory (354) which is a long-term storage device such as a flash memory.

The input device (370) includes a physical transducer such as the key pad and the pointing device. The communication module accomplishes sending and receiving of data through a mobile communication network.

FIG. 4 represents a schematic drawing of an apparatus for operating the user interface of the mobile terminal having a pointing device. Referring to FIG. 4, the device includes a pointing device (205), a control section (366), CD-GUI API (CD-GUI Application Programming Interface, 403), and CD-GUI (Configurable and Downloadable Graphic User Interface, 401). The pointing device (205) generates a button data and/or a motion data by users' manipulation, and transmits them to the control section (366). The control section (366) generates coordinate data and/or click data, double-click data, drag-start data, drag data, button-press data, button-release data, and drop data by receiving and processing the button data and/or the motion data from the pointing device (205). Thereafter, the control section (366) moves a position of a mouse pointer included in CD-GUI (403) which is displayed on the output section through the CD-GUI API (401), and performs an event corresponding to a specific icon. the CD-GUI (403) is based on a coordinate data and the event is based on the click data, double-click data, drag data, and drop data. Users can easily select various service icons included in the CD-GUI (403) by manipulating the pointing device (205), and configure CD-GUI (403) for their own tastes. In other words, users can setup and organize their own environments by downloading a service icon, a main screen, and a user setup screen provided from a service provider through a mobile internet. CD-GUI (403) according to the present invention, as described above, can configure a screen and download a desired service icon, main screen, user screen through mobile internet.

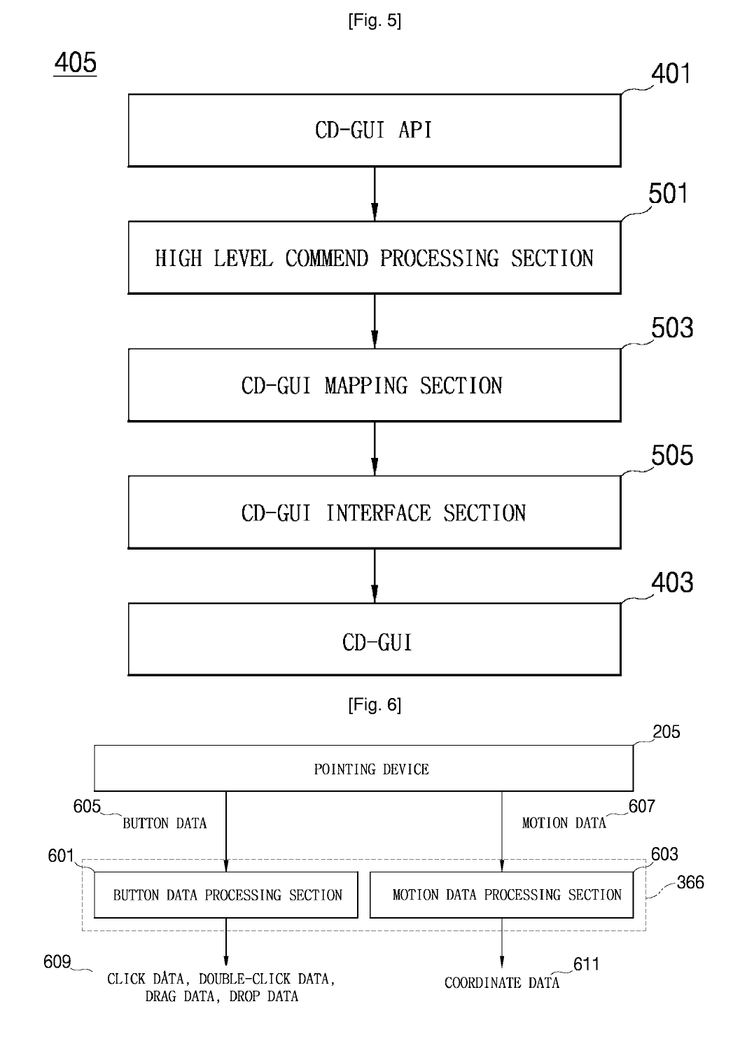

FIG. 5 presents a detailed drawing of CD-GUI API and CD-GUI. Referring to FIG. 5, the mobile terminal according to the present invention can use various OS (Operating System). The OS controls program operation by providing a high level command to API (Application Program Interface). The mobile terminal distinguishes CD-GUI (403) corresponding to the high level command provided from CD-GUI API (401) by a control signal of the control section, and includes a high level command processing section (501) which decodes the high level command and provides it to a corresponding section. A CD-GUI mapping section and a CD-GUI interface section (505) control the operation of CD-GUI (403) by the high level command through the high level command processing section (501). The high level command processing section (501) distinguishes an existence of CD-GUI corresponding to the high level command provided from CD-GUI API (401). If a corresponding CD-GUI (403) exists, the high level command processing section (501) decodes the high level command to a recognizable command by CD-GUI (403), and transmits it to CD-GUI mapping section (50) or control a message transmission. CD-GUI mapping section (503) receives the high level command from the high level command processing section (501) to control and output CD-GUI (403), does mapping the high level command to a device level command, controllable by CD-GUI (403), and provides the command to the CD-GUI (403) through CD-GUI interface section (505).

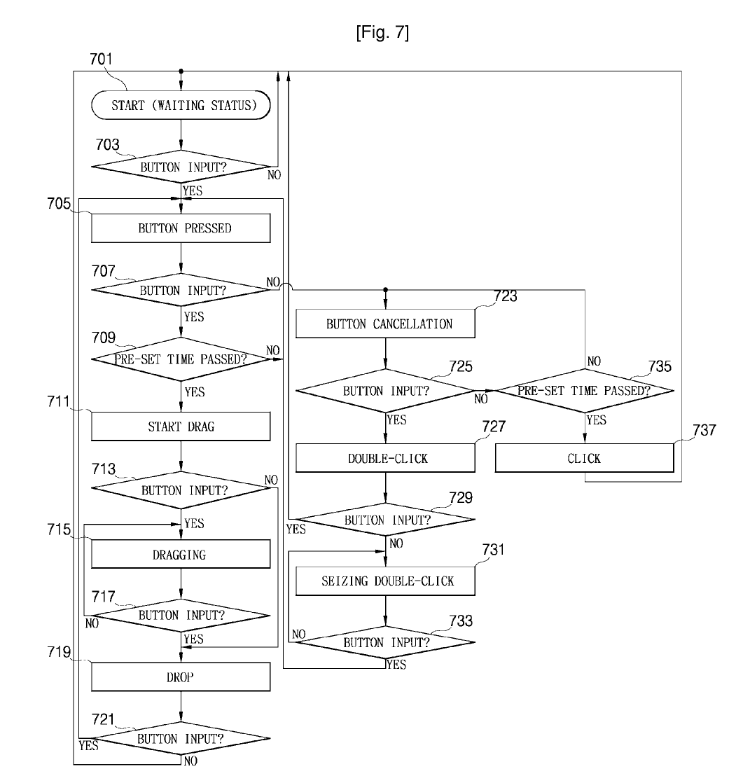

FIG. 6 shows a schematic drawing of a system structure of a control section. Referring to FIG. 6, the control section (366) includes a button data processing section (601) and a motion data processing section (603). The button data processing section (601) receives button data (605) generated from the pointing device (205) by user's manipulation. Thereafter, the button data processing section (601) generates and outputs click data, drag-start data, drag data, button-press data, button-release data, drag data, and drop data through an appropriate process of the button data (605). A generation mechanism of the button data (605), click data, drag-start data, drag data, button-press data, button-release data, drag data, and drop data (609) will be, in detail, explained in FIG. 7.

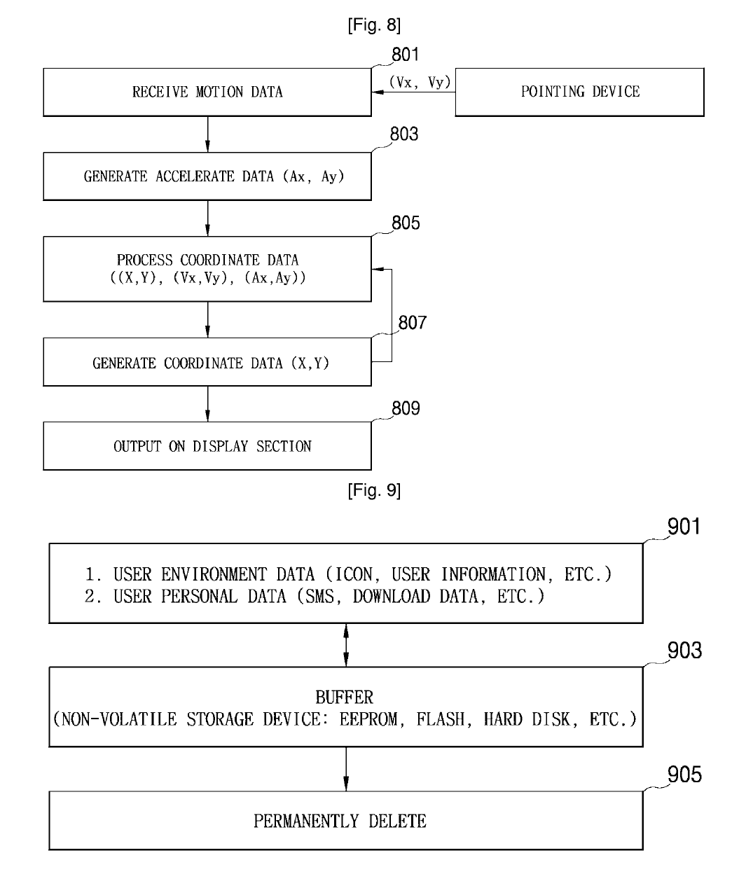

The motion data processing section (603) receives the motion data, especially velocity data, and thereafter, generates new coordinate data based on accelerate data which is produced from a prior coordinate data and the velocity data. Thereafter, the motion data (603) transmits the new coordinate data to CD-GUI API, and decides a position of a mouse pointer in CD-GUI. A process of generating the new coordinate data will be explained by referring to FIG. 8.

FIG. 7 demonstrates a flow chart about processing a button data. Referring to FIG. 7, A button data processing section, included in the control section, waits a button input from the pointing device (701). When there is the button input from the pointing device (703), the button data processing section sets a status as button pressed and searches whether there is a new button input or not (707). If there is a new button input, the button data processing section examines an excess of pre-set time (709), or otherwise, cancels the button pressed status (723). In examination of the pre-set time excess (709), If the pre-setup time is passed, the button data processing section starts a drag (711), or otherwise, returns to the button pressed status (705). In the start drag (711), the button data processing section receives the start drag from the pointing device. Thereafter, the button data processing section examines an existence of a new button input (713). If there is a new button input, the button data processing section performs dragging (715), or otherwise, performs drop (719). In dragging (715), the button data processing section generates drag data. After the dragging, the button data processing section examines an existence of a new button input from the pointing device (717). If the new button input exists, the button data processing section performs a drop (719), or otherwise, returns to dragging (715). In the drop (719), the button data processing section generates drop data. After the drop, the button data processing section examines an existence of a new button input from the pointing device (721). If the new button input exists, the button data processing section returns to the button pressed status (705), or otherwise, returns to the waiting status (701).

In a button cancellation (723), the button data processing section cancels a button pressed status, and thereafter examines an existence of a new button input from the pointing device (725). If the new button input from the pointing device exists, the button data processing section performs a double-click (727), or otherwise, examines an excess of a pre-set time (735). In the double-click (727), the button data processing section generates double-click data. In the examination of the excess of pre-set time, if the pre-set time is passed, the button data processing section performs a click (737), or otherwise, returns to the button cancellation (723). In the click (737), the button data processing section generates click data. After performing the double click (727), the button data processing section examines an existence of a new button input from the pointing device (729). If the new button input from the pointing device exists, the button data processing section returns to the waiting status (701), or otherwise, seizes a double click status (731). Thereafter, the button data processing section examines an existence of a new button input from the pointing device (733). If the new button input from the pointing device exists, the button data processing section returns to the button pressed status (705), or otherwise, seizes a double click status (731).

FIG. 8 illustrates a flow chart about processing motion data. Referring to FIG. 8, a motion data processing section included in the control section receives motion data, especially velocity data, from the pointing device (801). The motion data processing section generates accelerate data from amount of a velocity data change (803).

Thereafter, the motion data processing section generates a new coordinate data based on a pre-set coordinate data, the velocity data, and/or the accelerate data (805). Later, the new coordinate data is used to generate other coordinate data from a new motion data occurred by a user's pointing device manipulation. Thereafter, the motion data processing section transmits the new coordinate data to the CD-GUI API, and decides a position of the mouse pointer in the CD-GUI.

FIG. 9 explains a drawing of a method of user environment buffering. Referring to FIG. 9, user environmental data, including a service icon, user information and so on, and user personal data (901), including short message data, downloading data, and so on, are buffered in or loaded from a non-volatile storage device such as EEPROM, Flash Rom, and Hard Disk by a control from the control section. The stored data can be also permanently deleted by the control from the control section.

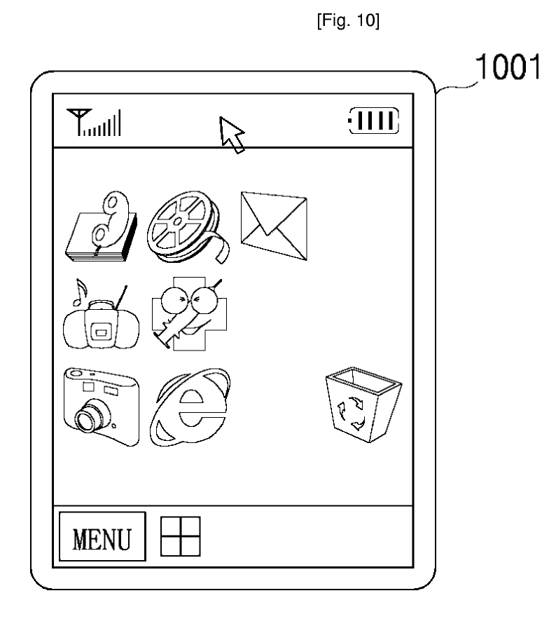

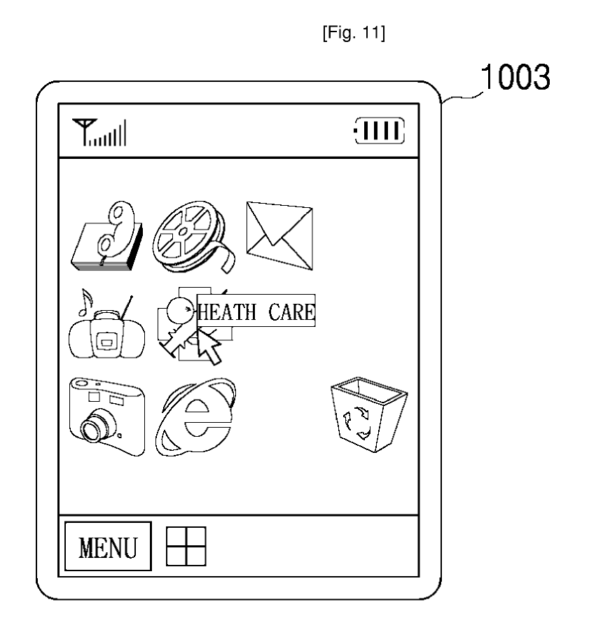

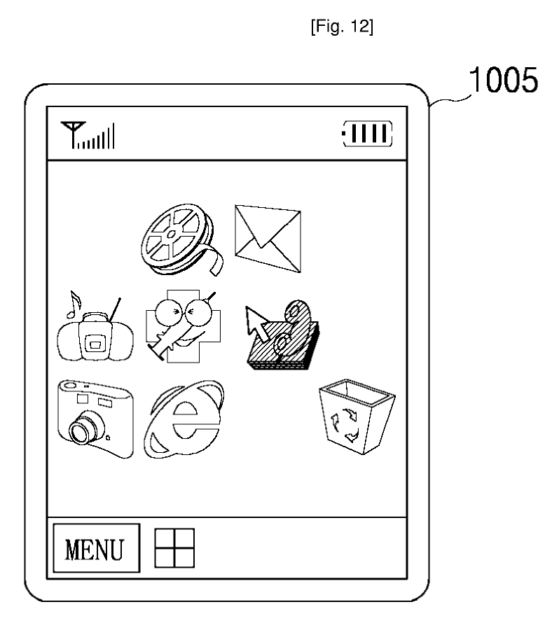

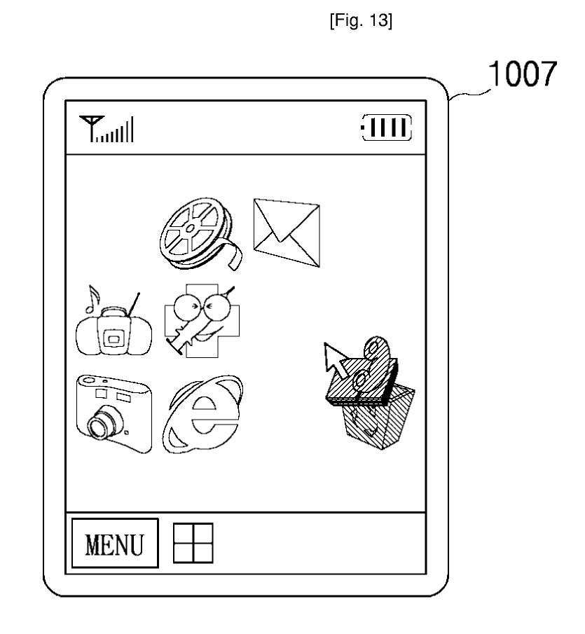

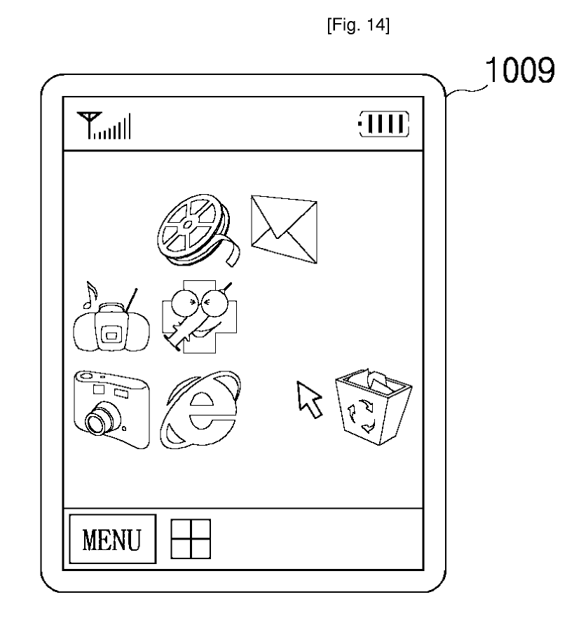

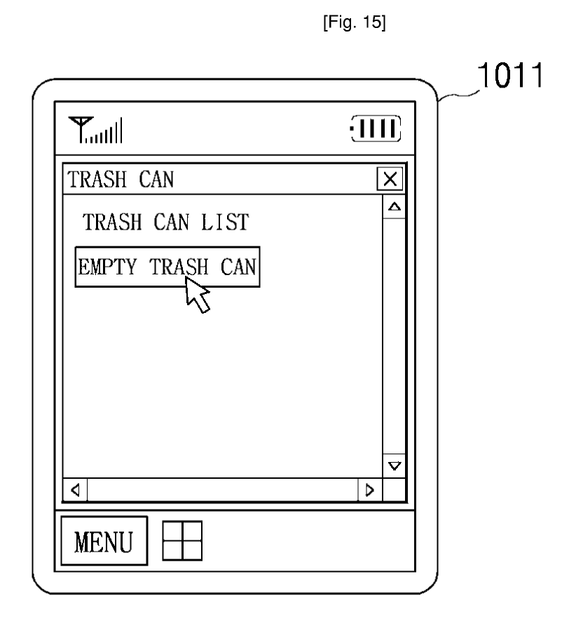

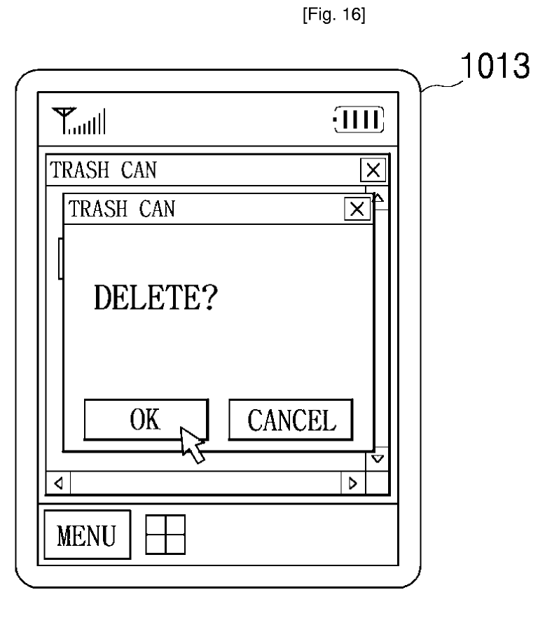

FIG. 10 depicts a drawing of a screen using CD-GUI, and FIG. 11 through 16 show a drawing of a screen representing examples of each function mounted in the mobile terminal according to the present invention.

Referring to FIG. 10, plurality of icons are arranged, and a mouse pointer is displayed on a screen using CD-GUI (1001). Users can move the mouse pointer to a specific icon and select it by manipulating a pointing device of mobile terminal. The screen (1003) using CD-GUI is configurable by user's manipulation. In other words, users can configure the screen by a manipulation of the pointing device, for example adding a icon downloaded through a mobile internet from a service provider.

Referring to FIG. 11 through FIG. 16, users can use a help function, an icon selection function, an icon drag function, an icon drop function, an icon double-click function, and a dialog function. In an icon help function example screen (1003) using CD-GUI, when users move a mouse pointer at a specific icon by manipulating the pointing device, the CD-GUI displays a corresponding help on the screen (1003) by a control of the control section. In an icon select function example screen (1005) using the CD-GUI, when users click on a specific icon, the CD-GUI displays a selection of the icon on the screen (1005). In an icon drag function example screen (1007) using the CD-GUI, when users drag a specific icon, the CD-GUI displays a dragging process on the screen (1007). In an icon drop function example screen (1009), when user release a button during dragging an icon, the CD-GUI displays a drop status of the icon on the screen (1009). In an icon double-click function example screen (1011), when users double-click on an icon, the CD-GUI displays a run of a function corresponding to the icon on the screen (1011). As a result of the double-click, a dialog function example screen (1013) using CD-GUI is displayed on the screen. In the dialog function example screen (1013), a dialog window inducing a specific action to users is displayed on the screen (1013).

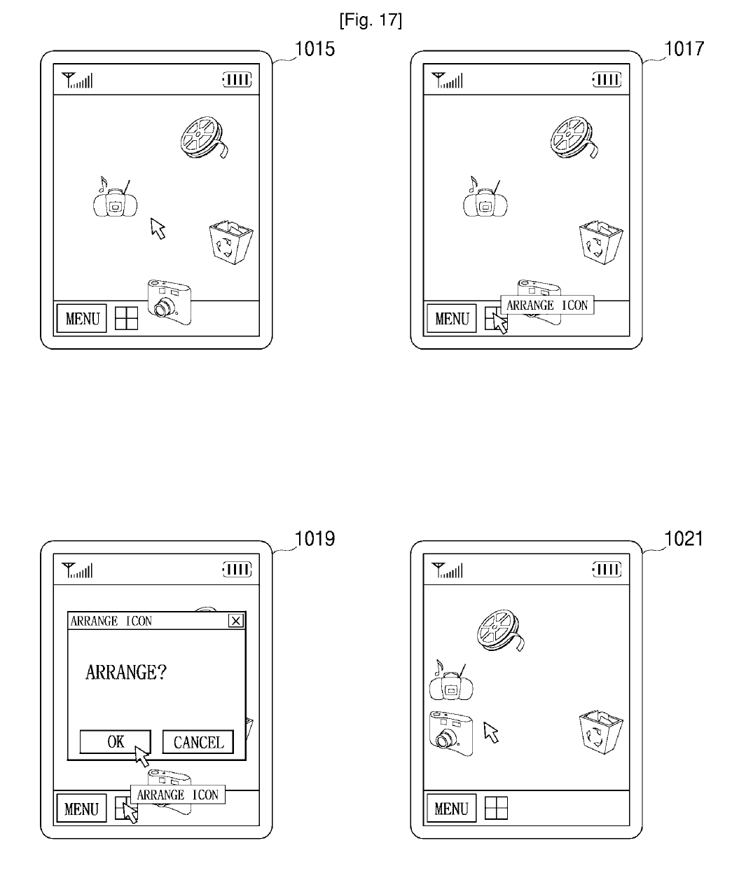

FIG. 17 represents a drawing of user screen structure. Referring to FIG. 17, by using example screens (1015, 1017, 1019, 1021), users can configure their own icon arrangement by manipulating the pointing device. When users select an icon, the CD-GUI displays a dialog window asking user's thought on the display section. When users select a desired item, for example a confirmation of arrange, the CD-GUI displays a corresponding result on the display section.

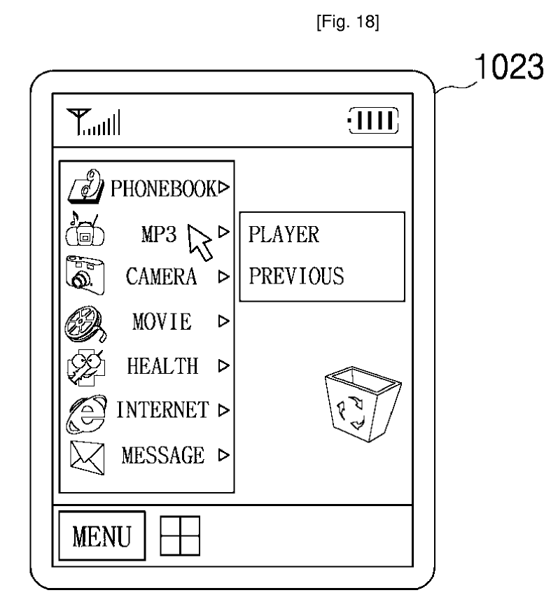

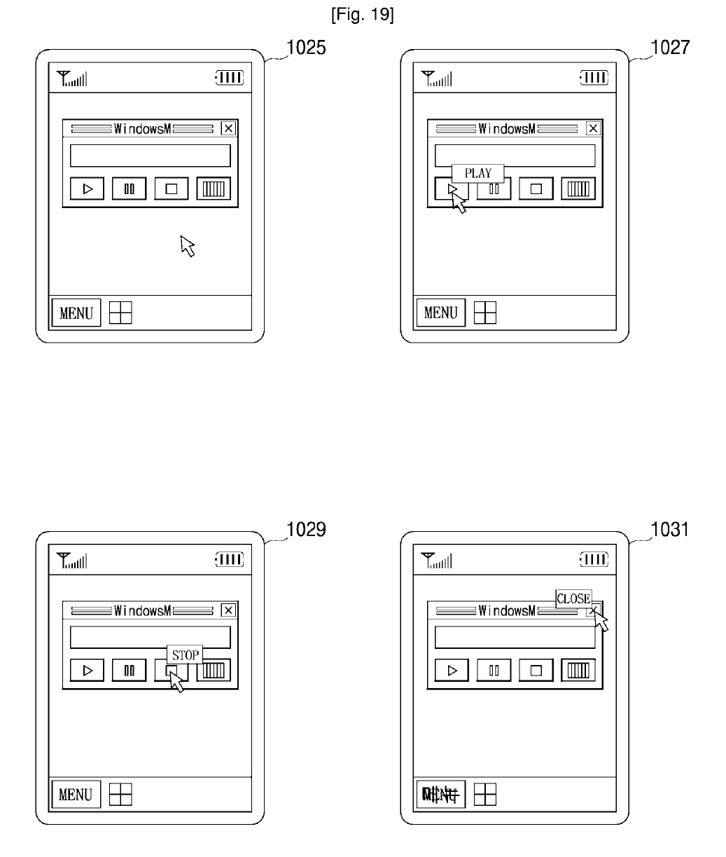

FIG. 18 demonstrates a drawing of a start screen on a display section, and FIG. 19 presents a drawing of a operating status of a specific application program.

Referring to FIG. 18 and FIG. 19, when users select a specific item by using a mouse pointer, for example MP3 item, the CD-GUI displays a corresponding menu on the display section. When users select a player in the menu, a player screen (1025) is displayed on the display section. Then user can use a specific application program by selecting a specific icon such as a play icon (1027), a stop icon (1029), a close icon (1031).

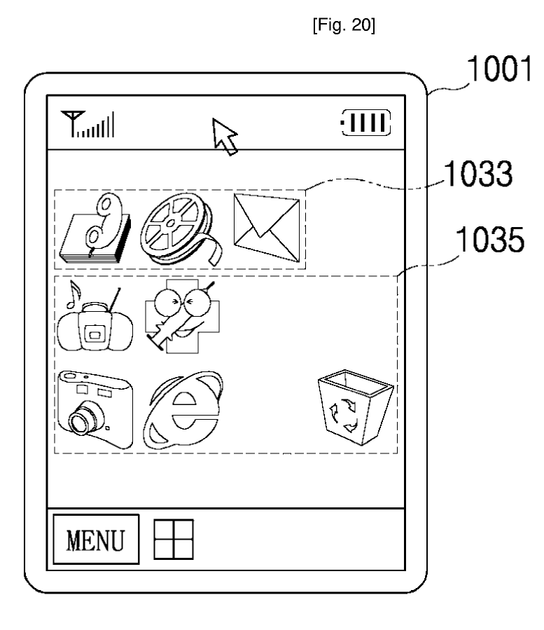

FIG. 20 illustrates a drawing of a service provider area and a configurable area in a user environment. Referring to FIG. 20, between a protected area (1033) and configurable area (1035) in the main screen, users can configure an environment of the configurable area (1035) by manipulation of the pointing device. That means user can configure only the environment of the configurable area (1035), but not protected area (1033).

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

### INDUSTRIAL APPLICABILITY

Accordingly, the present invention can provide a method and an apparatus for operating a configurable user interface of a mobile terminal having a pointing device.

Also, the present invention can provide a method and an apparatus for operating a user interface of the mobile terminal having the pointing device wherein users can easily select a specific icon.

In other application, the present invention can provide a method and an apparatus for operating a user interface of the mobile terminal having the pointing device wherein users can configure various environment by downloading various elements forming environment.

In other application, the present invention can provide a method and an apparatus for operating a user interface of the mobile terminal having the pointing device wherein users can easily program a specific function.

1. A mobile terminal having a pointing device comprising:
a pointing device generating and transmitting button and motion data by user's manipulation;
a control section controlling at least a datum processed by a button data processing section processing button data or a motion data processing section processing motion data transmitted from the pointing device; and
an application program interface managing user interface by receiving control data, wherein the user interface environment is configured by the control data generated by users' manipulation and an element forming the environment is downloadable.

2. The mobile terminal having the pointing device of claim 1, wherein the button data processing section generates one of among click data, double-click data, drag-start data, drag data, button-press data, button-release data, and drop data as control data based on the button data.

3. The mobile terminal having the pointing device of claim 1, wherein the motion data processing section generates coordinate data as control data based on the motion data.

4. The mobile terminal having the pointing device of claim 3, wherein the motion data are velocity data corresponding to move of a mouse pointer, the motion data processing section generates accelerate data from the velocity data, and the coordinate data are generated from one of the velocity data, the accelerate data, and a pre-coordinate data of the mouse pointer.

5. The mobile terminal having the pointing device of claim 1, wherein the user interface (CD-GUI) includes a configurable area which is configurable by user's manipulation, and a protected area which is non-configurable by user's manipulation.

6. A method for operating user interface of a mobile terminal having a pointing device comprising:
receiving at least a datum from button data or motion data by manipulating the pointing device;
generating control data based on received button data or motion data;
generating high level command in an application programming interface to manage the user interface based on the control data; and
operating the user interface by the high level command compared with the control data, wherein an environment of the user interface is manipulated by the control data generated by the user, and an environmental element is downloadable.

7. The method of claim 6, wherein the control data generated from the button data are one of the click data, double-click data, drag-start data, drag data, button-press data, button-release data, and drop data.

8. The method of claim 6, wherein the control data generated from the motion data is coordinate data.

9. The method of claim 8, wherein the motion data are velocity data corresponding to move of the mouse pointer, the motion data processing section generates accelerate data from the velocity data, and the coordinate data are generated from one of the velocity data, the accelerate data, and a pre-coordinate data of the mouse pointer.

10. The method of claim 6, wherein the user interface (CD-GUI) includes a configurable area which is configurable by user's manipulation, and a protected area which is non-configurable by user's manipulation.
